(19) United States
(12) Patent Application Publication
(10) Pub. No.: US 2008/0244912 A1
(43) Pub. Date: Oct. 9, 2008

(54) Optical Shaving Apparatus

(76) Inventor: Morgan Lars Ake Gustavsson, Newton, MA (US)

Correspondence Address: PROSKAUER ROSE LLP, ONE INTERNATIONAL PLACE, BOSTON, MA, 02110, US

(21) Appl. No.: 12/050,158

(22) Filed: Mar. 17, 2008

Related U.S. Application Data
(60) Provisional application No. 60/918,411, filed on Mar. 16, 2007.

(51) Int. Cl. B26B 19/00

(52) U.S. Cl. 30/165

(57) ABSTRACT

A compact and portable optical shaving device cuts hair shafts using electromagnetic radiation. In various embodiments, the optical shaving device includes a power source that connects to one or more optical components (e.g., arranged in an array). An optic, such as a blade, can connect to and aligns with the array of optical components. The optical component(s) can provide light to the optic based on electrical energy from the power source. The optical component(s) or the optic can manipulate and direct the electromagnetic radiation to cut the hair shafts.

### CROSS REFERENCE TO RELATED APPLICATIONS

This application claims the benefit of and priority to U.S. Provisional Patent Application No. 60/918,411, filed Mar. 16, 2007, the entire disclosure of which is incorporated herein by reference.

### FIELD OF THE INVENTION

The invention relates generally to the field of shaving, and more particularly to an apparatus for shaving with electromagnetic radiation.

### BACKGROUND OF THE INVENTION

Shaving, as currently practiced, has a number of deficiencies. Shaving with metal blades is often a source of irritation and damage to the skin. The damage is cumulative with each shaving and often a treatment involves suspension of shaving for an extended period of time. Also, hair removal is limited to the level of the surface of the skin. Consequently, a beard is visible soon after shaving.

Electromagnetic radiation, such as light, offers a way to cut hair closely without irritation or damage to the skin. Light cuts hair through the absorption of photons by melanin, pheomelanin, and water and through the scattering of light within the hair shaft. Light vertically incident on the skin can burn hair from the top of the skin and can temporarily or permanently destroy hair follicles to various depths in the skin. However, existing methods using light expose skin to irritation, pain, and, in certain cases, to damage in the form of burns, hyperpigmentation, or hypopigmentation, and are not meant to replace daily shaving with a blade.

Light conveyed by an optical fiber into a follicle may irradiate a single follicle at a time to a depth below the skin surface and lead to temporary or permanent hair removal. However, the technique is time-consuming when applied to a large area, requires considerable skill, and may lead to permanent loss of hair when only a temporary loss of hair is desired.

### SUMMARY OF THE INVENTION

The invention, in various embodiments, features an optical device for cutting or shaving hair. The optical device can include optical component(s) that generate electromagnetic radiation, such as light, and can include an optic or optics that direct or manipulate the electromagnetic radiation to cut or sever hair shaft(s) at, above or below the surface of the skin.

In one aspect, the invention features an apparatus for cutting hair shafts. The apparatus includes a power source providing electrical energy, an incoherent light source providing radiation in response to the electrical energy, and a waveguide receiving radiation from incoherent light source and providing divergent radiation to cut the hair shafts.

In another aspect, the invention features an apparatus for cutting hair shafts. The apparatus includes a coherent light source providing radiation and a plurality of optical components coupled to the coherent light source. At least some of the optical components spread to form a linear arrangement of optical components adapted to provide radiation to cut the hair shafts.

In still another aspect, the invention features an apparatus for cutting hair shafts. The apparatus includes a power source providing electrical energy, a plurality of optical components coupled to the power source, and an optic coupled to and aligned with the array of optical components. At least some of the optical components are arranged in an array. The optical components provide radiation in response to the electrical energy. The optic receives radiation from the plurality of optical components. The optic manipulates or directs the electromagnetic radiation to cut the hair shafts.

In yet another aspect, the invention features an apparatus for cutting hair shafts. The apparatus includes a lamp, a plurality of optical components coupled to the lamp, and an optic coupled to and aligned with the array of optical components. The lamp includes a housing, a first electrode, and a second electrode. The first electrode and the second electrode contain a plasma discharge in the housing between the electrodes to provide a substantially point source of radiation. The plurality of optical components are coupled to the lamp. At least some of the optical components are arranged in an array. The optical components receive radiation from the substantially point source of radiation. The optic receives radiation from the plurality of optical components, and manipulates or directs the radiation to cut the hair shafts.

In still another aspect, the invention features an apparatus for cutting hair shafts. The apparatus includes a source of radiation, a plurality of optical fibers cast in a resin, an optic coupled to the second end of the plurality of optical fibers, and a housing. The plurality of optical fibers receive the radiation from the source. The plurality of optical fibers include a curved region between a first end and a second end. The plurality of optical fibers spread to form a linear arrangement of optical fibers in the curved region. The optic manipulates or directs the electromagnetic radiation to cut the hair shafts. The source and the plurality of optical fibers are disposed in the housing, which is flexible in the curved region.

In other examples, any of the aspects above, or any apparatus or process described herein, can include one or more of the following features.

The waveguide can include a plurality of optical components coupled to the incoherent light source. At least some of the optical components can spread to form a linear arrangement of optical components. The optical components can include a plurality of optical fibers coupled to the incoherent light source or the coherent source.

An optic can be coupled to and aligned with the waveguide. The optic can receive radiation from the waveguide, and direct the electromagnetic radiation to cut the hair shafts. The waveguide or optical components can include a plurality of joined optical fibers, which can spread to form the linear arrangement of optical components at the second end.

The incoherent source can be a lamp including a housing, a first electrode, and a second electrode. The first electrode and the second electrode can contain a plasma discharge in the housing between the electrodes.

The optic can include a blade that is configured to transmit the electromagnetic radiation to the cutting edge of the blade. The electromagnetic radiation can be used, at least in part, to cut the hair shaft(s). The blade can include a transparent material.

The plurality of optical components can include a plurality of optical fibers cast in a resin. The plurality of optical fibers can have a first end and a second end, and can spread to form a linear arrangement of optical fibers at the second end.

The lamp and the plurality of optical components can be disposed in a housing. The housing can be flexible in a region of the plurality of optical components to maintain the optic in contact with a skin region comprising the hair shafts.

The plurality of optical components can be adapted to deliver the radiation, through the optic, along a surface of a skin region comprising the hair shafts.

A radiation coupling medium can couple the radiation from the source or lamp to a first end of the plurality of optical components.

The curved region of the optical components or the optical fibers can facilitate delivery of the radiation above, below, or along a skin region comprising the hair shafts.

The electromagnetic radiation can have one or more desired characteristics (e.g., wavelength, fluence level, pulse shape and pulse frequency). The optic, in turn, can receive and direct or manipulate the light to cut a hair shaft(s). For example, the optic can manipulate the light to provide a divergent light beam which is used to cut the hair shaft(s).

In various embodiments, the optical components can include at least one light source connected to multiple light guides, such as optical fibers or a waveguide. In some embodiments, the optical components can include multiple light sources that emit continuous wave light or pulses of light. The plurality of optical components can include a plurality of LEDs.

In some embodiments, the optic may include a light absorbing structure that converts the light to thermal energy capable of cutting the hair shafts. In certain embodiments, the optic includes a blade that guides the light to the cutting edge of the blade. The blade may include a transparent or translucent material. In one embodiment, a sharp edge of the blade and the light both contribute to the cutting of the hair shaft(s).

The optic can include a fluorescent material. The optic can diverge radiation. The optic can be adapted to diffuse radiation.

A beam homogenizer can evenly distribute the radiation from the source to the waveguide or plurality of optical fibers. A reflector can collect radiation from the source and direct the radiation to the waveguide or plurality of optical fibers.

Other aspects and advantages of the invention will become apparent from the following drawings, detailed description, and claims, all of which illustrate the principles of the invention, by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIGS. 1A and 1B shows an exemplary optical shaving device.

FIGS. 2A and 2B are cross-sectional views of proximal ends of optical fiber bundles.

FIGS. 3A and 3B are cross-sectional views of distal ends of optical fiber bundles illustrating arrangements of the optical fibers.

FIGS. 4A-4C are perspective views of optical fibers illustrating example light exiting angles.

FIGS. 5A-5C are cross-sectional views of distal ends of optical fiber bundles arranged in arrays.

FIGS. 6A and 6B are perspective views of example blade edges.

FIG. 7 is a side view of an unshaven man.

FIGS. 8A and 8B are cross-sectional views of blades being used to cut hairs on the unshaven man of FIG. 7.

FIGS. 9A-9D show an embodiment of an optical shaving device.

FIG. 10 shows a lamp for use in an optical shaving device.

FIG. 11 shows an embodiment of an shaving device.

### DESCRIPTION OF THE INVENTION

An optical shaving device can minimize irritation of the skin and lead to a healthier appearance. An optical shaving device can cut or sever hair to a level within a follicle, that is, beneath the level of the skin surface, thereby leading to a longer lasting shave, or the light can be directed to a hair shaft at or above the skin surface. An optical shaving device can be adapted for hand-held use. An optical shaving device can be drawn across the surface of the skin in a conventional safety razor-like fashion. For example, the optical shaving device can be adapted to deliver radiation substantially perpendicular to a hair shaft.

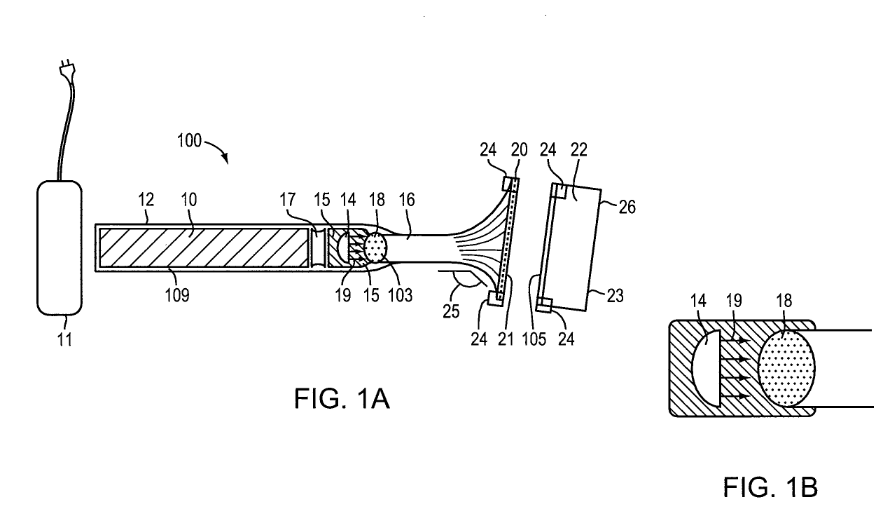

FIGS. 1A and 1B illustrate an exemplary embodiment of an optical shaver 100. The optical shaver 100 can be small and compact so that it is portable and useful in a variety of environments including a hotel, professional salon, clinic or home. The optical shaver 100 includes a battery 10, a housing 12, a source of electromagnetic radiation 14, a controller 17, a waveguide 16, a light coupling medium 15 to couple radiation 19 from the source 14 to a proximal or first end 18 of the waveguide 16, and an optic 22.

In various embodiments, the waveguide 16 can include one or more optical fibers (e.g., shown as fibers 103 in FIG. 1A). A bundle of optical fibers 103 can be spread out to form a linear arrangement of optical fibers 103 at the second end 20 of the waveguide 16. The optical fibers 103 can be joined. For example, the optical fibers 103 can be mechanically held, fused together or cast together. The optical fibers 103 can be fused by heat, epoxy, or cast in a resin, polymer, or lacquer. The resin can include polymethylmethacrylate (PMMA) or polyurethane (PU).

Light coupling medium 15 can be a reflector to collect radiation from source 14 and direct radiation to the waveguide 16.

In some embodiments, the waveguide 16 can be cast as a single optical element. The waveguide 16 can be a substantially solid optic that spreads to form a linear emitting surface at second end 20. The waveguide 16 can be formed from glass, crystal, a resin, or a polymer. Light coupling surface 21 of the waveguide 16 can have a sharp edge, which can facilitate cutting of the hair shaft(s).

The optic 22 can be coupled to the distal or second end 20 of the waveguide 16 through a coupling mechanism 24. The optic 22 can be referred to as a blade. The optic 22 can cut one or more hair shafts below, at, or above the surface of the skin by directing electromagnetic radiation to the hair shaft(s). The optic 22 can have a sharp edge to facilitate cutting of the hair shaft(s). The optic 22 can be an optional component of the optical shaver 100. For example, radiation exiting light coupling surface 21 can be used to cut a hair shaft below, at, or above the surface of the skin.

In some embodiments, more than one optic 22 can be used to deliver the radiation. In certain embodiments, light coupling surface 21 of waveguide 16 or optic 22 can be combined with a steel blade to cut hair shaft(s). The optical shaver 100 can vibrate or oscillate while cutting hair. For example, the optical shaver 100 can provide ultrasonic energy.

The battery 10 can be rechargeable, as by induction from a charger 11. In some embodiment, the battery 10 is disposable. In certain embodiments, the optical shaver 100 can be powered by a wireless power source. In some embodiments, a power source, such as an AC to DC converter or an AC supply, may be used in place of the battery 10.

Controller 17 can deliver electrical energy that can excite the source 14 to emit electromagnetic radiation. The controller 17 can be electrical circuitry, including a logic circuit. The controller 17 can provide electricity to the source 14 that corresponds to the wavelength, fluence, pulse duration, pulse shape, or pulse rate of the source 14.

The light source 14 can be a source of coherent electromagnetic radiation or a source of incoherent electromagnetic radiation. Coherent electromagnetic radiation sources include, but are not limited to, solid state lasers and diode lasers. Incoherent electromagnetic radiation sources include, but are not limited to, light emitting diodes (LED's), gas discharge lamps, xenon lamps, arc lamps, filament lamps, and fluorescent lamps.

The wavelength of the electromagnetic radiation can occupy all of, a portion of, or multiple portions of a range of wavelengths of radiation. For example, the source can be a broadband source or a narrowband source. The source can provide a band of wavelengths. The wavelength, wavelength(s), or band of wavelength(s) can be about 200 nm to about 4,000 nm. In some embodiments, the range is about 400 nm to about 2,600 nm. In certain embodiments, the range is about 400 nm to about 1,200 nm. The range can be about 450 nm to about 800 nm.

The radiation can be absorbed by the hair shaft to cut, sever, or score the hair shaft. In some embodiments, the wavelength(s) of the electromagnetic radiation can be selected to optimize the absorption of photons by chromophores in the hair shaft such as, for example, melanin, pheomelanin, water, or other endogenous chromophores. In addition, scattering of radiation in the hair shaft can cut the hair shaft. The radiation need not affect the bulb or bulge of the hair to effect a treatment.

In some embodiments, a chromophore (e.g., a stain, gel, or photosensitizer) can be introduced to the hair shaft, and the wavelength(s) of the electromagnetic radiation can be selected to optimize absorption of photons by the introduced chromophore. For example, individual hairs, a subset of the hairs, or substantially all the hairs can be stained. The wavelength(s) of the electromagnetic radiation can be matched to the stain. The introduced chromophore can be applied in a pattern (e.g., to draw a negative of an image) so that when the hair is removed the image is produced in the hair. Similarly, a material that does not absorb radiation can be applied to individual hairs or a subset of the hairs so that these hairs are not cut or resist cutting. The chromophore, alone or in combination with another substance, can be used to cool the skin, reduce the emission of smoke, and/or reduce odor during a treatment.

The source 14 can provide a continuous radiation or pulsed radiation. In some embodiments, the source 14 can provide a series of pulses of radiation or a repetitive series of pulses of radiation. The source 14 can provide radiation that is modulated (e.g., having a varying pulse shape or modulated continuous output). The source 14 can provide radiation that has a fixed intensity or a time varying intensity.

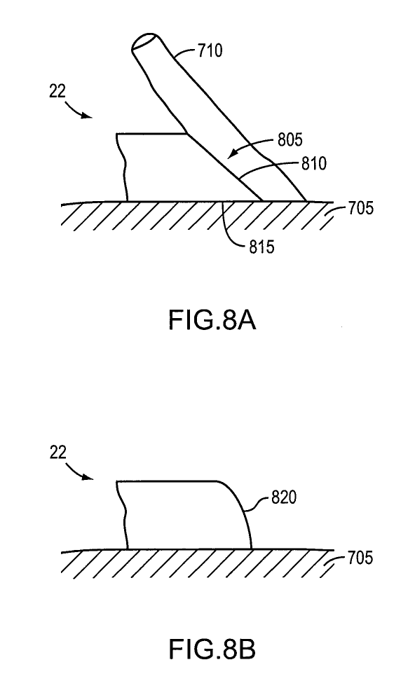

The controller 17 can permit control of at least one of the wavelength, fluence level, pulse shape, pulse frequency, or pulse duration of the radiation. Pulses of electromagnetic radiation corresponding to high peak power of limited duration can provide effective cutting of hair shaft(s) 710 (e.g., as shown in FIG. 8A).

In certain embodiments, the pulse duration can be about 1 microsecond to about 1 second, although longer and shorter pulse duration can be used. In some embodiments, the pulse duration can be about 100 microseconds to about 10 milliseconds. In some embodiments, the pulse duration can be about 1 millisecond to about 6 milliseconds.

The light source 14 can provide electromagnetic radiation with a fluence level of up to about 50 J/cm², although higher or lower fluence levels can be used depending on the application. In some embodiments, the fluence level can be about 2 J/cm² to 30 J/cm². In certain embodiments, the fluence level can be about 5 J/cm² to 25 J/cm². In some embodiments, the fluence level can be about 10 J/cm² to 20 J/cm². The fluence level can be about 8 J/cm², about 10 J/cm², about 12 J/cm², about 15 J/cm², or about 20 J/cm².

In some embodiments, about 10 J/cm² can be delivered at a pulse rate of about 10 Hz.

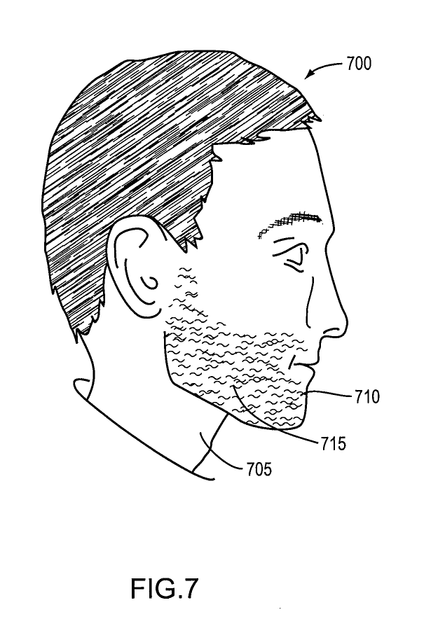

The radiation characteristics such as, for example, at least one of the wavelength, fluence level, pulse shape, pulse frequency, or pulse duration can be fixed or can be adjustable according to the color and/or coarseness of the hair 710 being treated (as well as other factors such as personal preferences of the user 700. For example, the user 700 (as shown in FIG. 7) may prefer to shave a bearded area 715 several times lightly rather than only once heavily. The pulse characteristics can also be adjusted according to the shaving stroke speed. For example, if the user 700 shaves slowly, settings, such as fluence, wavelength, repetition rate, pulse width and pulse shape can be changed accordingly. For example, for a shaver with a slower stroke, the repetition rate can be decreased.

In some embodiments, the shaving device can have a fixed setting. In certain embodiments, the device can include multiple settings that correlate to the shaving stroke speed. For example, a low setting can provide settings adequate for a slow shaving stroke. A high setting can provide settings adequate for a fast shaving stroke. An intermediate setting can provide settings adequate for a medium shaving stroke.

In some embodiments, the shaving device can be used as a trimmer (e.g., for beards). The shaving device can be adapted to cut hair shaft(s) about 0.5 mm to about 20 mm above a surface of the skin. In some embodiments, a guard affixed to the end of the shaving device directs the radiation to cut the hair at a predetermined length.

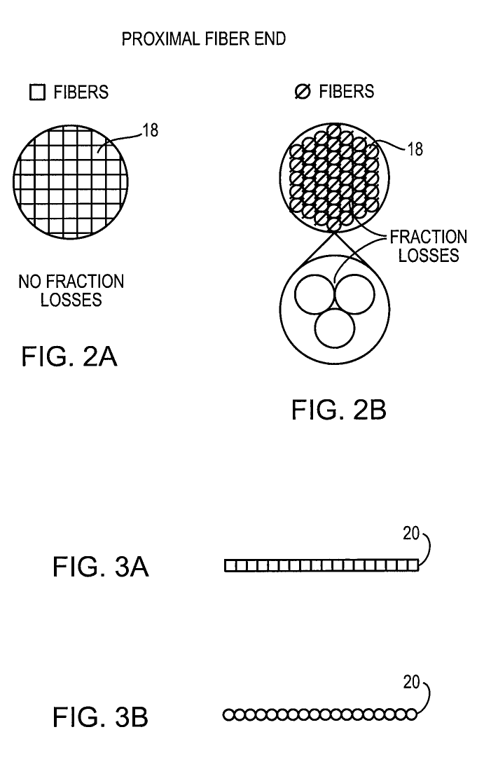

FIG. 2A illustrates a waveguide 16 formed from a bundle of optical fibers 103. The proximal or first end 18 of the optical fiber bundle can be a collection of optical fibers 103 of square cross-section or, as illustrated in FIG. 2B, of circular cross-section. The bundle of optical fibers 103 with circular cross-sections (FIG. 2B) can exhibit fraction losses as a result of the space between the optical fibers 103. The bundle of optical fibers 103 with square cross-sections (FIG. 2A), however, exhibit less fraction losses because the space between optical fibers 103 in the bundle is substantially eliminated. In certain embodiments, all or substantially all of the space between circular optical fibers can be filled with a light transmitting material, such as a resin or epoxy.

The cross-section of each optical fiber 103 can be about 250 microns to about 600 microns, although larger or smaller optical fibers can be used depending on the application. In certain embodiments, the cross-section can be about 400 microns.

Each optical fiber 103 or the waveguide 16 can have a cladding layer. The cladding layer can be about 100 microns and/or can be a percentage of the total thickness of the fiber or waveguide (e.g., about 10% of the total thickness).

Each optical fiber 103 or the waveguide 16 can have a reflective coating that facilitates transmission of the radiation thought the optical fiber or the waveguide by reflection.

As illustrated in FIG. 3A, the second end 20 of the optical fiber bundle can be joined as a linear array of optical fibers 103. FIG. 3B shows a linear array of circular cross-section optical fibers.

The second end 20 of the optical fiber bundle or the waveguide 16 can spread to form a linear array or have a linear configuration. The length can be about 2 cm to 5 cm, although longer or shorter linear configurations can be used. In certain embodiments, the length is about 2.8 cm. The width can be about 250 microns to about 600 microns, although wider or thinner configurations can be used. In one embodiment, the length is about 2.8 cm and the width is about 400 microns.

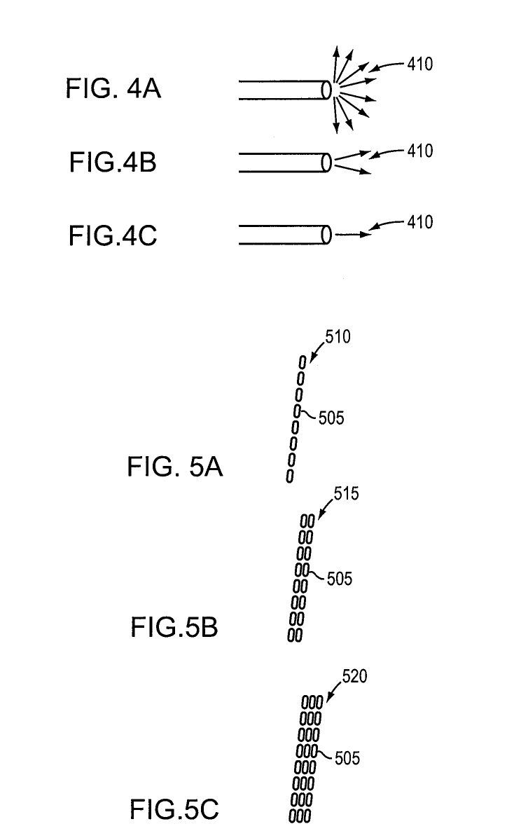

The second end 20 of the optical fiber(s) 103 or the light emission area 23 of the optic 22 can provide point sources 505 (FIG. 5) with a variety of light exiting angles, depending upon the shape of the second end 20 and the inherent properties of the fibers used. The spread of the electromagnetic radiation 410 exiting from the optical fiber 103 may be minimal, as illustrated in FIG. 4C, narrow, as illustrated in FIG. 4B, or substantially hemispherical, as illustrated in FIG. 4A.

A light coupling surface 21 at the second end 20 of the optical fibers 103 can be polished into a flat surface. The flat surface can have a sharp edge capable of cutting a hair shaft or delivering radiation. The second end 20 can focus or defocus the radiation.

In some embodiments, the second end 20 can diffuse radiation. For example, the second end 20 can diffuse radiation to enhance eye safety. The second end 20 can diffuse the radiation when the second end 20 is not in contact with the skin. In certain embodiments, the second end 20 can be frosted or etched to diffuse the radiation.

The second end 20 of the optical fiber bundle can include a single row 510 of point sources 505 of electromagnetic radiation as illustrated in FIG. 5A or multiple rows of point sources. For example, FIG. 5B illustrates a double row 515 of point sources 505 and FIG. 5C illustrates a triple row 520 of point sources 505.

In some embodiments, a double row of optical fibers can have a length of about 1.5 cm and a width of about 800 microns.

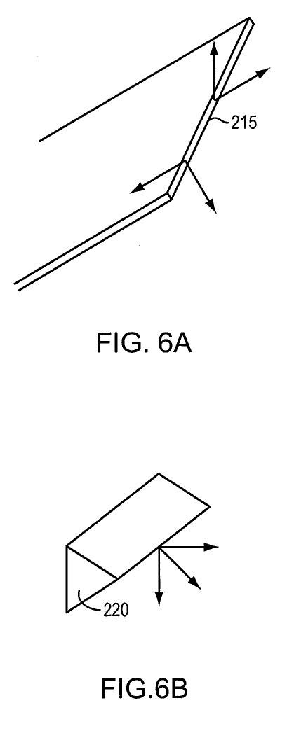

The optic 22 can receive light from the second end 20 of the optical fiber bundle 16. FIGS. 6A and 6B are perspective views of example light emission areas 21 of the waveguide 16 or light emission area 23 of the optic 22. The light emission area 21, 23 can have a rectangular emission area 215 as illustrated in FIG. 6A or a tapered emission area 220 for light emission as illustrated in FIG. 6B.

In certain embodiments, the point sources 505 can be provided by multiple light sources, such as LEDs or laser diodes. The multiple light sources can be positioned at or about the light coupling surface 21. The optic 22 can be coupled to light coupling surface 21. In certain embodiments, the optic 22 is not used and the multiple light sources direct radiation to the hair shaft(s). In some embodiments, the multiple light sources are positioned adjacent the first end 18 of the waveguide 16, and the waveguide directs radiation to the hair shaft(s).

Rows of LEDs or laser diodes can correspond in geometry to the single, double, triple, quad, or more rows of point sources illustrated in FIGS. 5A-5C, where individual sources can have various shapes and sizes. For example, the LED's can have dimensions of about 0.4 mm×0.4 mm or about 0.7 mm×0.7 mm. Furthermore, rows of LED's can be partial, e.g., a device can include at least one full row and at least one partial row of LED's. In some embodiments, an elongated light source can be embedded in the light coupling surface 21 instead of multiple light sources.

The optic 22 or blade can be made of an at least partially transparent material such as a polymer, crystal or glass. The optic 22 can be a waveguide. The optic 22 can be made of a material with a high refractive index or coated on at least one side with a suitable coating. In some embodiments, the optic 22 can have a cladding layer. The optic 22 can direct radiation via total internal reflection or can by reflection from a reflective coating disposed on at least one outer surface of the optic 22.

The optic 22 can be formed from glass and include an over coat, such as a polymer, glass, lacquer, or crystal coating. For example, if the optic 22 is formed of glass and cracks or breaks, the coating can prevent the glass from splintering. The optic 22 can be disposable and/or replaceable.

The optic 22 and/or the waveguide 16 can be disposed of and replaced if it wears out (e.g., no longer efficiently transmits radiation, becomes dull, becomes coated with organic material, or is broken) and/or at the discretion of the user.

Suitable coatings can include at least one of a metal such as, for example, aluminum, gold, and silver or at least one metal oxide. The optic 22 or blade can be detachably attached to the light coupling surface 21 such that the first coupling surface 105 of the optic 22 or blade matches the shape and the area of the light coupling surface 21. In some embodiments, the first coupling surface 105 of the optic 22 or blade can have a different shape or area than the light coupling surface 21. For example, the first coupling surface 105 can extend across a subset of LED's. A coupling element 24, such as a mechanical coupling element, including a hook, a slide, or a snap, and/or a media that matches the index of refraction of the optic 22 or blade with the index of refraction of the light coupling surface 21 may couple the optic 22 or blade to the light coupling surface 21.

As illustrated in FIG. 1, the optic 22 or blade can include a distal light emitting aperture or light emission area 23. The light emission areas 21 or 23 can be coated with a non-stick material 26, such as polytetrafluoroethylene (PTFE) (Teflon) or sapphire, so that burnt material (e.g., hair, dirt, oil, or fatty tissue) from the environment does not become burnt or coated on the light emitting surfaces 21, 23 of the waveguide 16 and/or blade 16.

The optic 22 or blade can be mounted or adjustably mounted at an angle 25 with respect to a handle 109 so as to be suitable for cutting hair shafts from various angles. For example, the optic 22 or blade can be mounted at an angle 25 with respect to the handle 109 so that the optic or blade is parallel to the skin and perpendicular to hair shafts during shaving. The angle of the optic or blade with respect to the skin can be between 0° and 90°.

As illustrated in FIG. 8A, the light emission area 23 can correspond to a side 810 of a wedge 805 where the flat side 815 rests against or substantially towards the skin 705 during shaving. This arrangement may minimize direction of electromagnetic radiation against and into the skin 705 as opposed to against and into the hair or hair shaft 710.

In some embodiments, the electromagnetic radiation or light can diverge or substantially diverge upon exiting from the light emitting area 21 of the waveguide 16 or the light emitting area 23 of the optic 22. Light not impinging upon a hair shaft 710 need not require collection to prevent undesired impingement upon and damage to skin 705 or other body parts, such as the eye, because the intensity of divergent light rapidly decreases with distance from the light emitting area 21, 23. Such divergence can be enhanced where the light emitting area 21, 23 has a convex end 820, as illustrated in FIG. 8B. In addition, the index of refraction of the waveguide 16 and/or optic 22 and the shape of the light emitting area 21 or 23 can be designed so that light not impinging on a hair shaft 710 in contact with the light emitting area 21 or 23 is at least partly internally reflected by the waveguide 16 or optic 22, thereby minimizing undesired exposure of the skin 705 and other body parts to the light.

As described above, embodiments of the optical shaving device 100 illuminate hair shafts growing in the skin with electromagnetic radiation to cut or shave the hair shafts. In some embodiments, the light emitting area 21 or 23 can be oriented parallel to a hair shaft, perpendicular to the hair shaft, or at an angle between parallel and perpendicular to the hair shaft to cut or shave the hair shaft. For example, radiation diverging from the light emitting area 21 or 23 can cut or shave the hair shaft. An incoherent light source can be selected to provide diverging light, or a diverging optic can be used to diverge light provided by a coherent source.

In certain embodiments, the optic 22 or blade can include optical components, such as modulators or waveguides, designed to manipulate or direct light to cut hair shafts 710. The modulators can manipulate the light 19 to provide a divergent radiance of light of up to 180 degrees. Thus, even when the optic 22 or blade is oriented perpendicular to hair shafts, the light can reach downwards into the hair follicle opening and cuts hair shafts below the surface of the skin. As a result, a person can achieve a closer and longer lasting shave.

The optic 22 or blade can include a light spectrum modulator made of absorbers, saturable absorbers, fluorescent absorbers or reflective particles. For example, the light spectrum modulator can include at least one fluorescent dye, such as pyrromethene, coumarin, and rhodamine, a laser crystal, such as a potassium titanium oxide phosphate (“KTP”) crystal, or a fluorescent material, such as ruby, alexandrite, erbium glass, Nd:YAG, Er:YAG, or titanium sapphire. The light spectrum modulator can convert electromagnetic radiation of a first bandwidth to electromagnetic radiation of a second bandwidth. In some embodiments, the light spectrum modulator can include at least one optical filter. The color of the optic 22 or blade doping is related to the color of the hair to be cut. For example, darker hair benefits from longer wavelengths whereas lighter hair benefits from shorter wavelengths. The optic 22 or blade can be disposable so that it may be replaced after a certain number of uses.

Prior to applying the light emission area 23 of the optic 22 or blade to or along the skin or to or along the hair to be cut, a media 113 may be applied to or along the skin to couple light 19 to the hair 710. In addition to light coupling, the media 113 can quench odors from burnt hair and/or prevent smoke and protect the skin by bulk heat absorption. For example, the media 113 can include an optical contact gel with a scent or perfume that neutralizes the scent of burnt keratin. Other embodiments of the optical shaving device 100 can include an integrated media 113 applicator that applies media 113 at a controlled rate during use of the optical shaving device 100. In some embodiments, the optical shaving device 100 includes a strip that applies moisturizer, scent, or a lubricant to the skin.

In various embodiments, the optic 22 or blade can include a light absorbing structure at the second aperture or end, such as a layer of carbon or zirconium oxide, that converts at least some of the light to thermal energy. The thermal energy can be used, in whole or in part, to cut the hair shafts or to heat the skin and open the skin's pores.

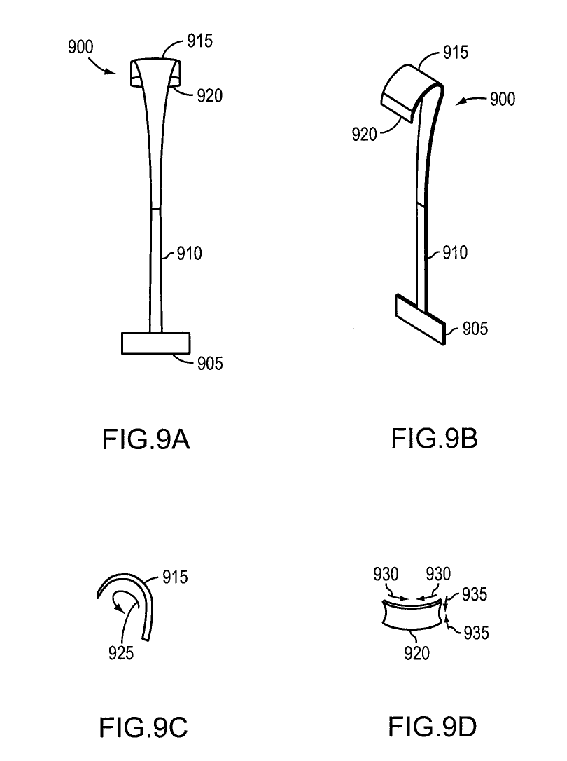

FIGS. 9A-9D show an embodiment of an optical shaving device 900. FIGS. 9A and 9B show a source 905 of electromagnetic radiation coupled to a beam homogenizer 910. A waveguide 915 can receive the radiation and provide the radiation to an optic 920. As in the embodiments described above, the optic 920 is optional. Waveguide 915 can deliver radiation to the hair shaft(s). The beam homogenizer 910 can be a waveguide that can distribute radiation received from the source. Waveguide 915 can spread from its proximal end to its distal end, so as to widen the region that the optic 920 can be expose with radiation. The beam homogenizer 910 can substantially evenly distribute the radiation to one or more elements of the waveguide 915. In certain embodiments, the waveguide 915 is an optical fiber bundle, which can be joined. Source 905 can include a reflector to collect radiation from source 905 and direct radiation to the beam homogenizer 910.

All or a portion of the optical shaving device 900 can be contained within a housing. The housing can protect the underlying optical components and can provide an ergonomic grip for a user. The optical shaver 900 can be adapted for hand-held and/or home based use. The optical shaver 900 can be drawn across the skin to cut hair.

FIG. 9C is a sectional view of the waveguide 915 that illustrates that as the waveguide 915 widens, it also becomes thinner. The optical fiber bundle 915 can be flexible. The flexibility of the waveguide 915 can allow the optic 920 to maintain contact with the skin surface as the optical shaving device 900 is drawn across the skin. In FIG. 9C, arrow 925 generally shows the direction of the flexibility of the waveguide 915.

In FIG. 9D illustrates flexibility of the optic 920. The flexibility of the optic 920 can allow the optic 920 to maintain contact with the skin surface as the optical shaving device 900 is drawn across the skin. Arrows 930 generally show that the optic 22 is flexible along its length dimension, while arrows 935 generally show that the optic 22 is flexible along its width dimension.

For example, curvature of the face, neck, underarm, knee, or leg can be accounted for by having features of an optical shaving device be flexible so that they can match the contours of the skin. The housing for the optical shaving device 900 can have a neck that is flexible to allow the waveguide 915 to flex. The housing can regulate the flexibility of the waveguide 915. In some embodiments, the housing can have a flexible pivot that allows the housing and the waveguide 915 to flex.

The curvature of the waveguide 915 can facilitate delivery of the radiation. The waveguide 915 can deliver radiation along the surface of the skin to cut or shave a hair shaft at or above the skin surface, or deliver radiation into a follicle to cut or shave a hair shaft beneath the level of the skin surface. In some embodiments, the radiation scores the hair shaft so that it can be broken by a mechanical force.

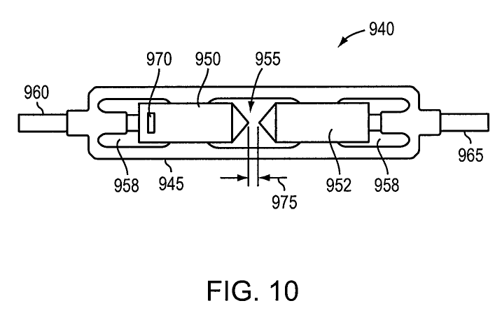

FIG. 10 shows a lamp 940 that can be used to provide radiation. The lamp 940 can be operated as a hybrid point source/arc lamp. The lamp 940 can be a component of the source 14 or the radiation source region 905. The lamp 940 can include a housing 945 an anode electrode 950 and a cathode electrode 952 in an inert gas. The lamp 940 defines volumes 955 and 958, which can house inert gas. The anode electrode 950 is coupled to an anode rod 950, and the cathode electrode 952 is coupled to a cathode rod 965. The anode electrode 950 can include a heatsink 970.

The housing 945 can be glass. In certain embodiments, the glass can be about 0.5 mm to about 1 mm thick ozone free quartz material, although thicker or thinner materials can be used depending on the application. The diameter of the housing can be about 3 mm to about 10 mm, although larger or smaller diameters can be used depending on the application. In certain embodiments, the diameter is about 4 mm or about 7 mm.

The electrodes 950 can support a plasma discharge to generate radiation. The electrodes 950 can contain the plasma discharge between the ends of the electrodes 950. For example, the plasma discharge can be produced so that it does not fill the bore 955 of the lamp 940. The bore 955 of the housing 945 can be large compared with the distance between the electrodes so that the plasma discharge does not fill the bore and/or so that the plasma discharge can be isolated from the housing 945. This can minimize stress on the housing 945, can increase the lifetime of the lamp 940 and can reduce the amount of heat generated by the lamp 940.

The distance 975 between the electrodes 950 can be about 0.5 mm to about 3 mm, although larger or smaller distances can be used depending on the application. In certain embodiments, the distance 975 is about 1.0 mm to about 2 mm.

The inert gas 955 can be Xenon. In certain embodiments, the pressure of the inert gas is about 450-1600 Torr, although higher or lower pressures can be used depending on the application. The anode and/or the cathode can include, for example, tungsten or an alloy of tungsten. Regions 958 are dead volumes that can account for expansion of the lamp 940 while in operation.

In certain embodiments, the electrical power applied across the electrodes can be about 40 W. The output of the lamp can be about 20 W.

The lamp 940 can be operated with or without cooling. Water or air cooling can be optionally used. Operation without water cooling can reduce the size and cost of the optical shaving device. A device that uses air cooling can use a portion of the air to blow smoke, debris, or smell away from the optic 22.

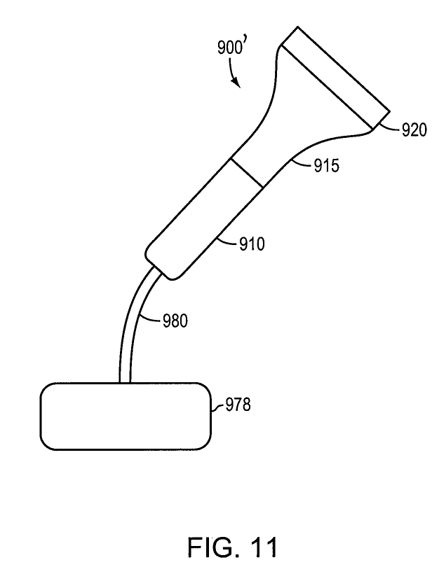

FIG. 11 shows an embodiment of an optical shaver 900′ that includes a remote housing 978. The remote housing 978 can include one or more of a source 905, a reflector, cooling for the source, and a controller. The remote housing 978 can be coupled to the beam homogenizer 910 via a cord 980. In certain embodiments, the cord 980 includes at least one waveguide (e.g., a liquid light guide or optical fiber) to transmit the radiation from the source 905 to the beam homogenizer 910. In some embodiments, the cord 980 can be the beam homogenizer 910, which is in communication with the waveguide 915. In some embodiments, cord 980 can be coupled to the optic 920 or can provide direct radiation to hair shaft(s). Source 905 can include a reflector to collect radiation from source 905 and direct radiation to the beam homogenizer 910.

While the invention has been particularly shown and described with reference to specific illustrative embodiments, it should be understood that various changes in form and detail may be made without departing from the spirit and scope of the invention.

What is claimed:

1. An apparatus for cutting hair shafts, comprising:
a power source providing electrical energy;
an incoherent light source providing radiation in response to the electrical energy; and
a waveguide receiving radiation from incoherent light source and providing divergent radiation to cut the hair shafts.

2. The apparatus of claim 1 wherein the waveguide comprises a plurality of optical components coupled to the incoherent light source, at least some of the optical components spreading to form a linear arrangement of optical components.

3. The apparatus of claim 2 wherein the optical components include a plurality of optical fibers coupled to the incoherent light source.

4. The apparatus of claim 1 further comprising an optic coupled to and aligned with the waveguide, the optic receiving radiation from the waveguide, the optic directing the electromagnetic radiation to cut the hair shafts.

5. The apparatus of claim 4 wherein the optic includes an electromagnetic radiation absorbing structure that is configured to convert the electromagnetic radiation to thermal energy capable of cutting the hair shafts.

6. The apparatus of claim 4 wherein the optic includes a blade that is configured to transmit the electromagnetic radiation to the cutting edge of the blade, the electromagnetic radiation used, at least in part, to cut the hair shafts.

7. The apparatus of claim 6 wherein the blade includes a transparent material.

8. The apparatus of claim 2 wherein the plurality of optical components include a plurality of joined optical fibers, the plurality of joined optical fibers having a first end and a second end and spreading to form the linear arrangement of optical components at the second end.

9. The apparatus of claim 4 wherein a plurality of optical components are adapted to deliver the radiation, through the optic, along a surface of a skin region comprising the hair shafts.

10. The apparatus of claim 4 wherein the optic includes a fluorescent material.

11. The apparatus of claim 1 wherein the incoherent source includes a plurality of LEDs.

12. The apparatus of claim 1 wherein the incoherent source comprises a lamp including a housing, a first electrode, and a second electrode, the first electrode and the second electrode containing a plasma discharge in the housing between the electrodes.

13. The apparatus of claim 12 wherein the waveguide includes a plurality of optical components coupled to the lamp, at least some of the optical components arranged in an array.

14. The apparatus of claim 13 further comprising an optic coupled to and aligned with the array of optical components, the optic receiving radiation from the plurality of optical components, the optic manipulating or directing the radiation to cut the hair shafts.

15. The apparatus of claim 12 wherein the plurality of optical components include a plurality of joined optical fibers, the plurality of joined optical fibers having a first end and a second end and spreading to form a linear arrangement of optical fibers at the second end.

16. The apparatus of claim 4 further comprising a housing in which the incoherent source and the waveguide are disposed, the housing being flexible to maintain the optic in contact with a skin region comprising the hair shafts.

17. The apparatus of claim 1 further comprising a beam homogenizer to evenly distribute the radiation from the incoherent light source to a first end of the waveguide.

18. The apparatus of claim 1 further comprising a reflector to collect radiation from the incoherent light source and direct the radiation a first end of the waveguide.

19. An apparatus for cutting hair shafts, comprising:
a coherent light source providing radiation; and
a plurality of optical components coupled to the coherent light source, at least some of the optical components spreading to form a linear arrangement of optical components adapted to provide radiation to cut the hair shafts.

20. The apparatus of claim 19 further comprising an optic coupled to and aligned with the plurality of optical components, the optic receiving radiation from the plurality of optical components, the optic directing the electromagnetic radiation to cut the hair shafts.

21. The apparatus of claim 19 wherein the plurality of optical components include a plurality of joined optical fibers, the plurality of joined optical fibers having a first end and a second end and spreading to form the linear arrangement of optical components at the second end.

22. The apparatus of claim 19 wherein the plurality of optical components are adapted to deliver the radiation, through the optic, along a surface of a skin region comprising the hair shafts.

23. The apparatus of claim 19 further comprising a beam homogenizer to evenly distribute the radiation from the coherent source to a first end of the plurality of optical components.

24. The apparatus of claim 19 further comprising a housing in which the coherent source and the plurality of optical components are disposed, the housing being flexible to maintain the optic in contact with a skin region comprising the hair shafts.

25. The apparatus of claim 19 further comprising a reflector to collect radiation from the coherent source and direct the radiation to the plurality of optical components.

26. An apparatus for cutting hair shafts, comprising:
a source of radiation;
a plurality of joined optical fibers, the joined plurality of optical fibers receiving the radiation from the source, the plurality of optical fibers having:
a first end;
a second end; and
a curved region between the first end and the second end, the plurality of optical fibers spreading to form a linear arrangement of optical fibers in the curved region;
an optic coupled to the second end of the plurality of optical fibers, the optic manipulating or directing the electromagnetic radiation to cut the hair shafts; and
a housing in which the source and the plurality of optical fibers are disposed, the housing being flexible in the curved region

27. The apparatus of claim 26 wherein the housing is flexible in a region of the plurality of optical fibers to maintain the optic in contact with a skin region comprising the hair shafts.

28. The apparatus of claim 26 wherein the curved region facilitates delivery of the radiation along a skin region comprising the hair shafts.

29. The apparatus of claim 26 further comprising a beam homogenizer to evenly distribute the radiation from the source to the plurality of optical fiber.

30. The apparatus of claim 26 further comprising a reflector to collect radiation from the source and direct the radiation to the plurality of joined optical fibers.
